(19) United States
(12) Patent Application Publication
(10) Pub. No.: US 2019/0143279 A1
(43) Pub. Date: May 16, 2019

(54) AN INJECTION ARRANGEMENT FOR INJECTION OF A UREA SOLUTION INTO AN EXHAUST GAS PASSAGE

(71) Applicant: SCANIA CV AB, Södertälje (SE)

(72) Inventor: Ingemar LUNDIN, Tystberga (SE)

(73) Assignee: SCANIA CV AB, Södertälje (SE)

(21) Appl. No.: 16/091,051

(22) PCT Filed: Mar. 14, 2017
(86) PCT No.: PCT/SE2017/050242

§ 371 Date: Oct. 3, 2018

(30) Foreign Application Priority Data
Apr. 11, 2016 (SE) 1650483-9

(51) Int. Cl. B01F 3/04; B01F 5/00; B01F 5/04; F01N 3/20; F01N 3/28

(52) U.S. Cl. CPC B01F 3/04049; B01F 5/0057; B01F 5/0486; F01N 2610/1453; F01N 3/2892; F01N 2240/20; F01N 2610/02; F01N 3/2066

(57) ABSTRACT

The invention relates to an injection arrangement for injection of a urea solution into an exhaust gas passage. The injection arrangement comprises a periphery wall element forming an inner space which has an extension in a longitudinal direction from a first closed end and a second open end, where the exhaust gases leaves the inner space, wherein the periphery wall element further comprises an inlet opening located at a radially outer position of the inner space. The injection arrangement further comprises flow means configured to create a rotating exhaust gas flow around a longitudinal center axis of the inner space of the periphery wall element and an injection member configured to inject the urea solution into the inner space, wherein the injection member comprises a plurality of injection nozzles arranged in at least two different longitudinal positions in the inner space.

### CROSS-REFERENCE TO RELATED APPLICATION(S)

This application is a national stage application (filed under 35 § U.S.C. 371) of PCT/SE2017/050242, filed Mar. 14, 2017 of the same title, which, in turn claims priority to Swedish Application No. 1650483-9, filed Apr. 11, 2016 of the same title; the contents of each of which are hereby incorporated by reference.

### FIELD OF THE INVENTION

The invention relates to an injection arrangement for injection of a urea solution into an exhaust gas passage.

### BACKGROUND OF THE INVENTION

One way of reducing emissions of nitrogen oxides from diesel engines is to use a technique called SCR (selective catalytic reduction). This involves a reducing agent in the form of a urea solution being supplied in a specific dose to the exhaust gases in the exhaust line of a diesel engine. When the urea solution is sprayed into the exhaust line, the resulting finely divided solution becomes vaporized in contact with the hot exhaust gases so that ammonia is formed. The mixture of ammonia and exhaust gases is then led through an SCR catalyst in which the nitrogen in the nitrogen oxides in the exhaust gases reacts with the nitrogen in the ammonia to form nitrogen gas. The oxygen in the nitrogen oxides reacts with the hydrogen in the ammonia to form water. The nitrogen oxides in the exhaust gases are thus reduced in the catalyst to nitrogen gas and water vapor. With correct dosage of urea, the emissions of nitrogen oxides can be greatly reduced.

The urea solution can be supplied to the exhaust gases by means of an injection member which injects the urea solution in finely divided form in an inner space of an exhaust passage. The inner space may be located in a silencer. However, it is difficult to supply the urea solution in a manner such that it evaporates completely before it comes in contact with an inner wall surface of the inner space. The walls of the inner space usually has a lower temperature than the exhaust gases especially in case they are in contact with the surrounding air. As a consequence, a film of unevaporated urea solution may be formed on the inner wall surfaces of the inner space. The film can be moved in the flow direction in the passage by the exhaust gases. After a certain distance, the water in the urea solution is evaporated. The remaining solid urea evaporates significantly slower. In case the layer of solid urea becomes thick enough, the urea and its decomposition products will react with themselves. This results in the formation of primitive polymers on urea base, so-called urea lumps. The urea lumps could in time block the flow in the exhaust passage.

### SUMMARY OF THE INVENTION

The object of the present invention is to provide an injection arrangement where urea solution is injected into an inner space of an exhaust gas passage in a manner such that the urea solution substantially always has time to vaporize in a short portion of the exhaust gas passage.

This object is achieved by the device defined in the characterizing part of claim 1. The device comprises an inner space in which an injection member injects the urea solution. The exhaust gases is directed into the inner space, via an inlet opening, such they obtain an at least partly transversely rotary movement in the inner space. The movement of the exhaust gases brings the injected urea solution with such that it receives a corresponding transversely rotary movement in the inner space in contact with the exhaust gases. As a consequence, the exhaust gases and the urea solution obtain a relatively long mixing length and thereby long mixing time in the inner space and it is lot of time for the urea solution to vaporize. The inner space may be designed with a relatively short longitudinal extension. Thus, it is possible to vaporize the urea solution in a short longitudinal portion of the exhaust gas passage. As a consequence, the inner space may be arranged relative close to the SCR catalyst which may shorten the length of the exhaust gas passage. Furthermore, it is possible to vaporize an increased quantity of urea solution. The flow means may be guide vanes which directs the exhaust gas flow into the inner space in the above described direction. Alternatively the flow means may include a suitably designed part of the exhaust passage in an upstream position of the inlet opening.

According to an embodiment of the invention, said flow means is configured to direct the exhaust gas in an at least partly transverse direction along an inner surface of said periphery wall. The exhaust gas flow along the inner surface of the inner space forms a barrier which makes it difficult for the urea solution to hit the inner surfaces of said periphery wall. Furthermore, the exhaust gases heat the inner surfaces of said periphery wall, such that possible unvaporized urea solution hitting the inner wall surface will be quickly vaporized.

According to an embodiment of the invention, the inlet opening has a straight extension in the longitudinal direction of the inner space. In this case, exhaust gases are directed into the inner space from an inlet opening arranged in a specific angular position on the periphery wall element. Alternatively, the inlet opening extends at least 360° around the longitudinal center axis. In this case, it is possible to direct exhaust gases from all angular positions into the inner space, via the inlet opening. In both cases, the inlet opening may have a longitudinal extension corresponding to at least half the longitudinal extension of the inner space. In this case, the exhaust gases are supplied to the entire or at least a main part of the longitudinal length of the inner space. However, it is possible to use an inlet opening having a shorter longitudinal extension.

According to an embodiment of the invention, the injection member has an extension in a radially inner position of the inlet opening. In this case, it is possible to inject urea solution into the exhaust gases as soon they enter the inner space. The injection member may have a longitudinal length corresponding to the longitudinal length of the inlet opening. In this case, the entire exhaust gases flow entering the inner space will come in contact with the injected urea solution. The injection nozzles may be designed such that they inject the urea solution in substantially the same direction as the direction of exhaust gas flow entering the inner space via the inlet opening. As a consequence, the exhaust gases and the urea solution will substantially immediately provide a corresponding rotary movement in the inner space.

According to an embodiment of the invention, the injection member comprises injection nozzles arranged at at least two different radial distances from the center longitudinal axis. Such a design favors droplets of unvaporized urea solution to obtain rotary movements at different distances from the longitudinal center axis. Furthermore, it facilitates a uniform distribution of the urea solution in the inner space. The injection nozzles may be arranged at regular intervals along a longitudinal length of the injection member. Such a design further increases the possibility to distribute the urea solution in a uniform manner in the inner space.

According to an embodiment of the invention, the periphery wall element extends 360° around the longitudinal center axis from a first wall portion to a second wall portion which is located in a radially inwardly position of the first wall portion wherein said radial distance defines the inlet opening. In this case, an inlet opening is formed having a longitudinal extension corresponding to the longitudinal length of the inner space. The longitudinal extension of the inlet opening defines the width of the opening. The radial distance between the first wall portion and the second wall portion defines the height of the inlet opening. In this case, the injection member may be arranged on the second wall portion. Since the second wall portion is located radially inwardly of the first wall portion, the risk that the urea solution hits the inner surface of the periphery wall element is substantially eliminated since the exhaust gas flow is located between the injected urea solution and the periphery wall. The radial distance between the periphery wall element and the longitudinal center axis may decrease continuously from the first wall portion to the second wall portion. In this case, the periphery wall element has the shape of a spiral extending around the longitudinal center axis.

According to an embodiment of the invention, the periphery wall element forms an inner space with a continuously increasing cross section area in the longitudinal direction from the first end to the second end. In this case, the inner space is substantially shaped as a cone or a truncated cone. Alternatively, the periphery wall element forms an inner space with a constant cross section area in a longitudinal direction from the first end to the second end. In this case, the inner space is substantially shaped as a cylinder.

According to an embodiment of the invention, the injection arrangement is arrange in a silencer in an exhaust gas line of a vehicle. Such a silencer may include several exhaust treatment components such as a SCR-catalyst.

### BRIEF DESCRIPTION OF THE DRAWINGS

In the following preferred embodiments of the invention are described with reference to the attached drawings, on which:

FIG. 1 shows an exhaust gas line of a combustion engine including an injection arrangement according to the invention,

FIG. 2 shows a sectional view of the silencer in FIG. 1,

FIG. 3 shows the injection arrangement in FIG. 2 more in detail,

FIG. 4 shows a sectional view in a plane A-A of the injection arrangement in FIG. 3,

FIG. 5 shows a second embodiment of the injection arrangement,

FIG. 6 shows a sectional view in a plane B-B of the injection arrangement in FIG. 5

FIG. 7 shows a third embodiment of the injection arrangement, and

FIG. 8 shows a sectional view in a plane C-C of the injection arrangement in FIG. 7.

### DETAILED DESCRIPTION OF THE INVENTION

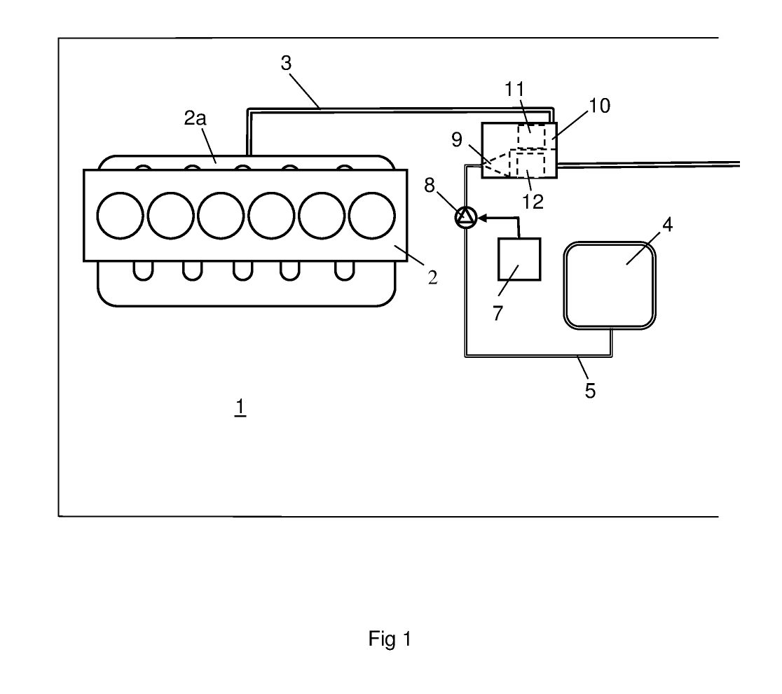

FIG. 1 shows schematically a vehicle 1 driven by a combustion engine 2 which may be a diesel engine. The vehicle 1 can be a heavy vehicle. The exhaust gases from the cylinders of the combustion engine 2 are directed, via an exhaust manifold 2a, to an exhaust line 3. The exhaust line 3 is provided with components for SCR (Selective Catalytic Reduction). A urea solution which is stored in a tank 4 is supplied to the exhaust gases. The urea solution is directed, via a urea line 5, to an injection arrangement 9 injecting the urea solution into the exhaust gases. A control unit 7 controls the supply of urea solution from the tank 4 to the injection arrangement 9 by means of a pump 8. The control unit 7 may be a computer unit provided with a suitable software for the control of the pump 8. The control unit 7 may receive information about a number of operating parameters whereupon it calculates the amount of urea solution to be supplied to the exhaust gases at which the emissions of nitrogen oxides in the exhaust gases are reduced in an optimal manner.

The injection arrangement 9 is arranged in a silencer 10 in the exhaust line 3. In this case, the silencer 10 also contains a schematically indicated particulate filter 11 and a SCR-catalyst 12. The silencer 10 may also contain other exhaust treatment components such as an oxidation catalyst and an ammoniac slip catalyst. The injected urea solution is heated in the silencer 10 by the exhaust gases to a temperature at which it vaporizes. The vaporized urea solution is converted to ammonia which enters the SCR-catalyst 12. In the SCR-catalyst 12, the nitrogen in the ammonia reacts chemically with the nitrogen in the nitrogen oxides such that nitrogen gas is formed. The hydrogen in the ammonia reacts chemically with the oxygen in the nitrogen oxides such that water is formed. Thus, the nitrogen oxides in the exhaust gases are reduced in the SCR-catalyst 12 to nitrogen gas and water vapor.

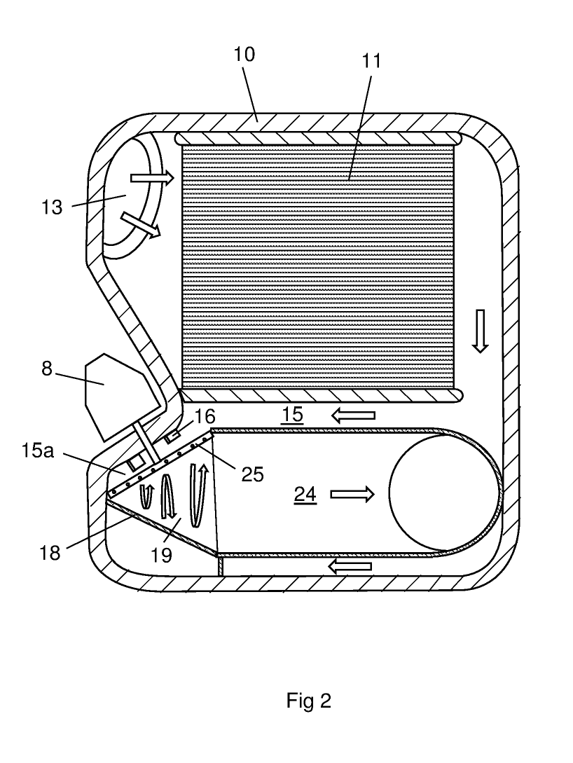

FIG. 2 shows a cross sectional view of the silencer 10. The exhaust gases enters the silencer 10 via an inlet opening 13. Initially, the exhaust gases flow through the particulate filter 11. Thereafter, the exhaust gases flows through an inlet passage 15 towards the injection arrangement 9. The inlet passage 15 has an end portion 15a provided with guide vanes 16. The guide vanes 16 direct the exhaust gas flow into the injection arrangement 9.

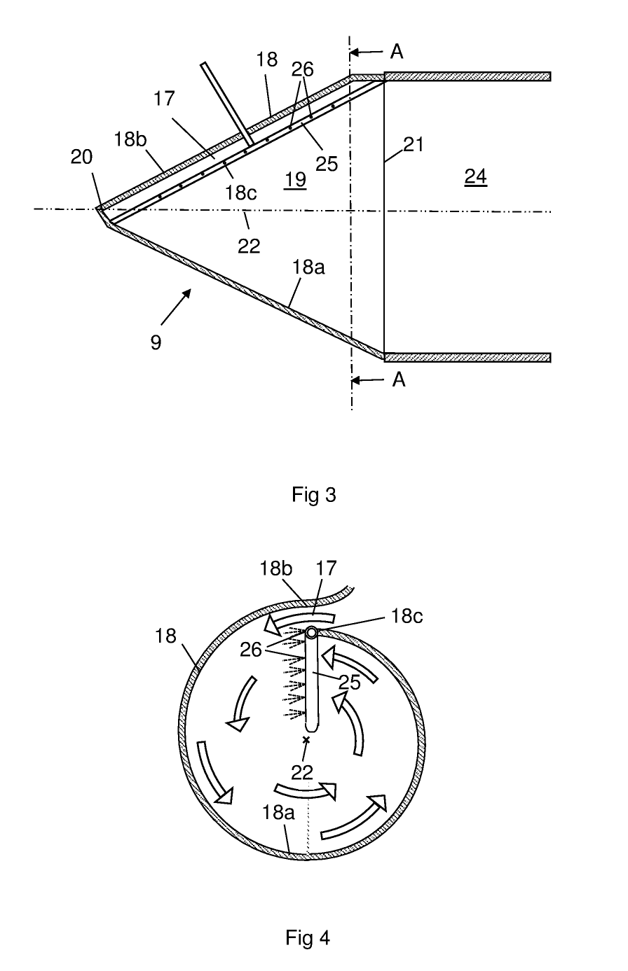

FIG. 3 shows the injection arrangement 9 more in detail. The injection arrangement comprises an inlet opening 17, to an inner space 19 defined by a periphery wall 18. The inner space 19 has a longitudinal extension defined by the distance between a first closed end 20 and a second open end 21 of the periphery wall element 18. In this embodiment, the inner space 19 has a continuously increasing cross section area in a longitudinal direction from the first closed end 20 to the second open end 21. A longitudinal center axis 22 of the inner space 19 is indicated. The exhaust gases leaves the inner space 19 via the open end 21 and enters an outlet passage 24 directing the exhaust gases to the SCR catalyst 12 indicated in FIG. 1. At least a part of the outlet passage 24 is arrange inside the inlet passage 15. As a consequence, the exhaust gases in the outlet passage 24 is heated by the exhaust gases in the inlet passage 15.

FIG. 4 shows a transverse sectional view of the body in a transverse plane A-A in FIG. 3. The periphery wall element 18 of the body has curved shape of 360° in the transverse plane A-A. The periphery wall element 18 has an extension from a first wall portion 18b to a second wall portion 18c which is located in a radially inwardly position of the first wall portion 18b. The wall 18 has a curved shape such that the radial distance from the inner wall surface 18a to the longitudinal center axis 22 decreases substantially continuously from the first wall portion 18b to the second wall portion 18c. Thus, the periphery wall element 18 has a spiral-shape in the transverse plane A-A. The radial distance between the first wall portion 18b and the second wall portion 18c defines the height of the inlet opening 17 for exhaust gases to the inner space 19. The inlet opening 17 has a width corresponding to the longitudinal extension of the inner space 19. The design of the inlet opening 17 and the guide vanes 16 in FIG. 2 creates an exhaust gas flow into the inner space 19 in a substantially transverse direction in relation to the longitudinal center axis 22. The exhaust gas flow follows a curved path along the inner wall surface 18a and around the longitudinal center axis 22.

An injection member 25 is configured to inject urea solution into the inner space 19. The injection member 25 and the periphery wall element 18 may be manufactured by stainless steel. Stainless steel is resistant to the corrosive exhaust heat and gases. Alternatively, they may be manufactured by copper or a suitable metal alloy. The injection member 25 is elongated and it has a tubular shape. The injection member 25 has a longitudinal extension along an edge surface of the second wall portion 18c. The injection member 25 is provided with a plurality of injection nozzles 26 in different longitudinal positions in the inner space 19. The injection member 25 is attached to the second wall portion 18c. The injection nozzles 26 are arranged in a row on one side of the injection member 25 such that they inject the urea solution in the flow direction of the exhaust gases entering the inner space 19. Furthermore, the urea solution is injected into the inner space at a radial distance from the first wall position 18b of the periphery wall element 18. Said radial distance is defined by the height of the inlet opening 17.

During operation of the combustion engine 1, the control unit 7 receives information about, for example, the flow rate and the temperature of the exhaust gases in the exhaust gas line 3. The control unit 7 calculates by means of, for example, these informations, the quantity of urea solution to be supplied to the exhaust gases in order to reduce the amount of nitrogen oxides in the exhaust gases in an optimal manner. The control unit 7 control the pump 8 such that it supplies the calculated quantity of urea solution, to the injection member 25. The supplied urea solution is injected into the inner space 19 via the injection nozzles 26 in different longitudinal positions of the inner space 19 and at different radial distances from the longitudinal center axis 22.

The above mentioned injection arrangement 9 has a plurality of advantages. The inlet flow of exhaust gases to the inner space 19, via the inlet opening 17, prevents in an effective manner the injected urea solution to hit the inner wall surfaces 18a. The exhaust gases heats the inner wall surface 18a such that possible urea solution hitting the inner surface 18a will be evaporated in a quick manner. The rotated exhaust gas flow in the inner space 19 provides a substantially uniform distribution of unvaporized droplets of urea solution in the entire inner space 19. The rotary movement of the exhaust gases provides a corresponding rotary movement of the urea solution. The rotary movement of the exhaust gases and the urea solution in a substantially transverse direction to the longitudinal center axis 22 results in a long mixing time and evaporation time for the urea solution in a very short longitudinal portion of the exhaust line. The downstream located exhaust gas passage 24 in the silencer 10 can be made short. Thus, it is possible to arrange the SCR-catalyst in a position relative close to the inner space 19 which saves space in the silencer 10.

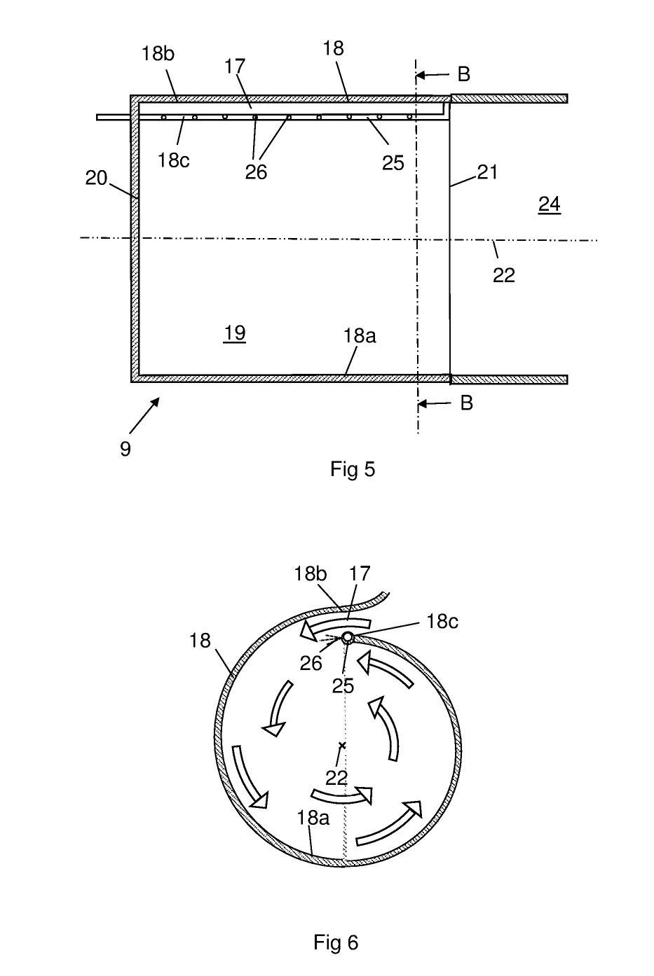

FIGS. 5 and 6 show an alternative embodiment of the injection arrangement 9. In this case, the injection arrangement 9 comprises a periphery wall element 18 having an inner wall surface 18a forming an inner space 19 with a constant cross sectional area in a longitudinal direction between the first end 20 and the second end 21. The function of this embodiment corresponds to the function of the embodiment shown in FIGS. 3 and 4.

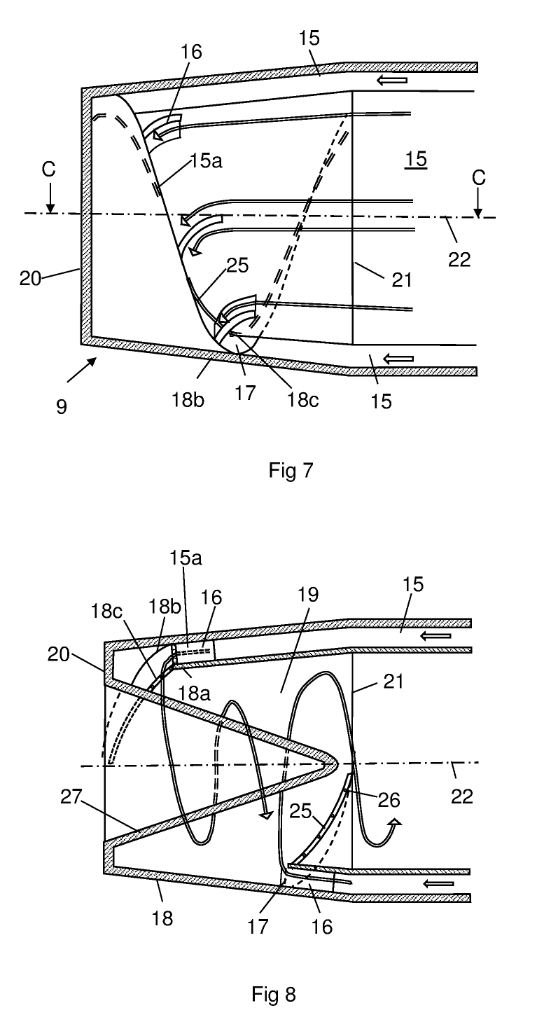

FIGS. 7 and 8 show a further alternative embodiment of the injection arrangement 9. The exhaust gases flow through an inlet passage 15 towards the injection arrangement 9. The inlet passage 15 has an end portion 15a provided with guide vans 16. The guide vans 16 direct the exhaust gas flow into the injection arrangement 9. The rotating exhaust gas flow is created with the guide vanes 16. The periphery wall element 18 is provided with a spiral-shaped inlet opening 17 to the inner spacer 19. The inlet opening 17 has a longitudinal extension corresponding substantially to the longitudinal extension of the periphery wall element 18 at the same time as it extends at least 360° around the periphery wall element 18. In this case, exhaust gases are supplied, via the inlet opening 17, to substantially the entire inner space 19 from different angle positioner. A conical member 27 reduces the volume of the inner space 19. The conical member 27 has an extension from the first end 20 to the second end 21. In this case, the volume of the inner space 19 increases from the first end 20 to the second end 21.

An injection member 25 is arranged at an inner surface 18a of the periphery wall element 18 in a position radially inwardly of the inlet opening 17. The injection member 25 has a corresponding spiral shape and longitudinal extension as the inlet opening 17. The injection member 25 is provided with injection nozzles 26 at constant intervals. The injection nozzles 26 inject urea solution in the exhaust gases entering the inner space 19 via the inlet opening 17. The exhaust gases provide a continued rotary movement in the inner space 19. The rotary movement of the exhaust gases bring the urea solution with such that they together rotate around the longitudinal center axis 22 in a more or less transverse direction. The common rotary movement of the urea solution in contact with the exhaust gases results in a long mixing time and evaporation time for the urea solution. Also in this case, it is possible to arrange an SCR-catalyst 12 in a position relative close to the inner space 19.

The invention is not restricted to the embodiments described on the drawing but may be varied freely within the frame of the claims.

1. An injection arrangement for injection of a urea solution into an exhaust gas passage, wherein the injection arrangement comprises:
a periphery wall element forming an inner space which has an extension in a longitudinal direction between a first closed end and a second open end, where the exhaust gases leaves the inner space, wherein the periphery wall element further comprises an inlet opening located at a radially outer position of the inner space;
flow means configured to create a rotating exhaust gas flow around a longitudinal center axis of the inner space of the periphery wall element; and
an injection member configured to inject the urea solution into the inner space, wherein, the injection member comprises a plurality of injection nozzles arranged in at least two different longitudinal positions in the inner space.

2. An injection arrangement according to claim 1, wherein said flow means is configured to direct the exhaust gas flow in an at least partly transverse direction along an inner surface of said periphery wall element.

3. An injection arrangement according to claim 1, wherein the inlet opening has a longitudinal direction corresponding to at least half the longitudinal extension of the inner space.

4. An injection arrangement according to claim 1, wherein the inlet opening has a straight extension in the longitudinal direction of the inner space.

5. An injection arrangement according to claim 1, wherein the inlet opening extends at least 360° around the longitudinal center axis.

6. An injection arrangement according to claim 1, wherein the injection member has an extension in a radially inner position of the inlet opening.

7. An injection arrangement according to claim 1, wherein the injection nozzles are designed such that they inject urea solution in substantially the same direction as a flow direction of the exhaust gases entering the inner space.

8. An injection arrangement according to claim 1, wherein the injection member comprises injection nozzles arranged at at least two different radial distances from the longitudinal center axis.

9. An injection arrangement according to claim 1, wherein the injection member has a longitudinal length corresponding to the longitudinal extension of the inlet opening.

10. An injection arrangement according to claim 1, wherein the periphery wall element extends 360° around the longitudinal center axis from a first wall portion to a second wall portion located in a position radially inwardly of the first wall portion wherein said radial distance defines the inlet opening.

11. An injection arrangement according to claim 10, wherein the radial distance between periphery wall element and the longitudinal center axis decreases continuously from the first wall portion to the second wall portion.

12. An injection arrangement according to claim 10, wherein the injection member is arranged on the second wall portion.

13. An injection arrangement according to claim 1, wherein the periphery wall element forms the inner space with a continuously increasing cross section area in a longitudinal direction from the first end to the second end.

14. An injection arrangement according to claim 1, wherein the periphery wall element forms the inner space with a constant cross section area in a longitudinal direction from the first end to the second end.

15. An injection arrangement according to claim 1, wherein the injection arrangement is arranged in a silencer in an exhaust gas line of a vehicle.
